(19) United States
(12) Patent Application Publication
(10) Pub. No.: US 2003/0007662 A1
(43) Pub. Date: Jan. 9, 2003

(54) Enhanced watermark computing method

(75) Inventor: Peter Bernhard Kaars, Cupertino, CA (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 09/898,248

(22) Filed: Jul. 3, 2001

(51) Int. Cl. G06K 9/00

(52) U.S. Cl. 382/100

(57) ABSTRACT

A value added watermarking technology is provided to permit enhanced information services. In such a technology a characteristic pattern is derived for a piece of content and the characteristic pattern is associated with content-related information. The content-related information may be stored in a remote database and retrieved using the characteristic pattern. The characteristic pattern is translated in a watermark to be embedded in the piece of content. After embedding in the piece of content, the watermark enables a user to access the content-related information when playing out marked content with a player equipped with the appropriate software to detect and read the watermark.

### FIELD OF THE INVENTION

The invention relates to the fields of content watermarking and content distribution.

### BACKGROUND ART

Fingerprinting, also sometimes referred to as hashing, and watermarking are two well known technologies to protect and authenticate a piece of audio or video content.

A watermark is a signal or pattern inserted in audio or video content. Two types of watermarks may be distinguished, depending upon whether the watermark is visible/invisible in video content, or audible/inaudible in audio content. An invisible or inaudible watermark should be imperceptible so that the rendering quality of marked content is not compromised. Any watermark is designed to be difficult for non-authorized persons to remove, if not impossible, and any watermark is also designed to survive common audio and video processing such as digital-to-analog conversion, analog-to-digital conversion, filtering or compression. Watermarks in marked content are generally detectable only by the appropriate software. Watermarks usually aim at identifying the origin, transmission path, author, owner, usage rights or authorized users of content rather than ensuring the authenticity or integrity of content.

It is to be noted that watermarking content implies the transformation of the content from its original form to another form, in which the watermark is embedded. This distinguishes watermarking from fingerprinting. In fingerprinting, original content remains intact but another file is created that describes original content.

A fingerprint is possibly computed using hash algorithms applied to digital content. Hashing is a way, by which content can be identified. In hashing, an algorithm typically derives values from a characteristic parameter of portions of content and computes the hash values therefrom. The sequence of hash values is usually much shorter than original digital content. It is impossible or infeasible to compute backward from the hash values to original content. The hash values may be used for various applications. For example, each time digital content such as a song or video clip is created the hash values can be calculated and saved with it so that each time content is electronically published or rendered, the hash values are published with it. Thus if a person wants to know if the correct version has been received, the hash values can be computed and compared with the values provided with content.

International application WO 99/17537 describes a technique for identifying a digital object using a digital watermark for authenticating copyright ownership. The technique includes a first step of encrypting a message derived from the source data on the digital object to obtain an encrypted message digest. Then, the technique includes deriving a watermark from the encrypted message digest and incorporating the watermark in the source data. Such a technique aims at reinforcing security and provides a watermarking technology that is invertible.

### SUMMARY

It is an object of the invention to provide a technique using watermarks to give users access to additional content-related information.

It is a further object of the invention to provide an enhanced content distribution service.

To this end, the invention relates to a method of computing a watermark for a piece of content. A method of the invention first comprises computing a characteristic pattern representative of the piece of content. The characteristic pattern is associated with content-related information. Then, the watermark is computed for the piece of content from the characteristic pattern and the watermark enables access to the content-related information.

In such a method, the piece of content is processed so that a watermark is obtained from a characteristic pattern representative of the piece of content. The characteristic pattern is created from the piece of content and associated with content-relevant information of any sort. The characteristic pattern is a set of data or values that allows identifying content and the characteristic pattern is possibly transmitted along with content or alone without content. The characteristic pattern may be a fingerprint. In the invention, the characteristic pattern is converted to a watermark adapted to content. The watermark is computed such that it enables a user to access information about content. The watermark may be thereafter embedded in content. In the invention, the content-related information is retrievable or accessible using the watermark. For example, the content-related information may have been initially indexed in a database of records using a respective hash derived for content, the hash being a type of characteristic pattern representative of content in this example. A given record of information for content is then retrievable using the hash. A watermark is derived based on the hash and may thereon be used to retrieve from the database the record associated with content. Alternatively, the content-related information is incorporated in the watermark itself. The watermark may also be derived from the content-related information.

In the invention, computing successively the characteristic pattern and the watermark and embedding the watermark in content may be done at any stage in the transmission of the content. Such a method may enable a service provider to enhance an existing entertainment broadcast service by giving access to additional content-related information. By incorporating such a watermark in a broadcast content, a user can easily retrieve information associated with content that is likely to be of interest to the user such as title, name of the artists and so on. A method of the invention permits to take advantage of existing fingerprinting technologies to provide a value-added watermarking technology.

In a further embodiment of the invention, the content-related information is stored in a remotely accessible database and is referenced by the characteristic pattern.

In such an embodiment the database used may already exist. The database may be comprised of records of information associated with respective contents. The records may be referenced by a certain type of characteristic pattern, e.g. a fingerprint derived using a predetermined algorithm. Once derived, the characteristic pattern may then be used to browse and search the database for a record associated with the content. If a match is found, the watermark can be derived from the characteristic pattern and thereafter embedded in the content. Thus, when receiving the marked content a user can retrieve the appropriate record in the database from the watermark. Alternatively, the database is created while computing the characteristic pattern and the watermark.

Further, a watermarking device of the invention comprises deriving means configured to generate a characteristic pattern of the content and configured to associate the characteristic pattern with content-related information. Such a device also comprises watermarking means configured to compute a watermark for the content on the basis of the characteristic pattern. The watermark enables access to the content-related information.

### BRIEF DESCRIPTION OF THE DRAWINGS

The invention is explained in further details, by way of examples, and with reference to the accompanying drawings wherein:

FIG. 1 illustrates a transmission path of a digital content;

FIG. 2 is a block diagram of an embodiment of a watermarking arrangement of the invention;

FIG. 3 is a block diagram of an embodiment of a watermarking arrangement of the invention;

FIG. 4 is a block diagram of an embodiment of a watermark embedding device of the invention; and,

FIG. 5 illustrates an enhanced content distribution service of the invention.

Elements within the drawing having similar or corresponding features are identified by like reference numerals.

### DETAILED DESCRIPTION

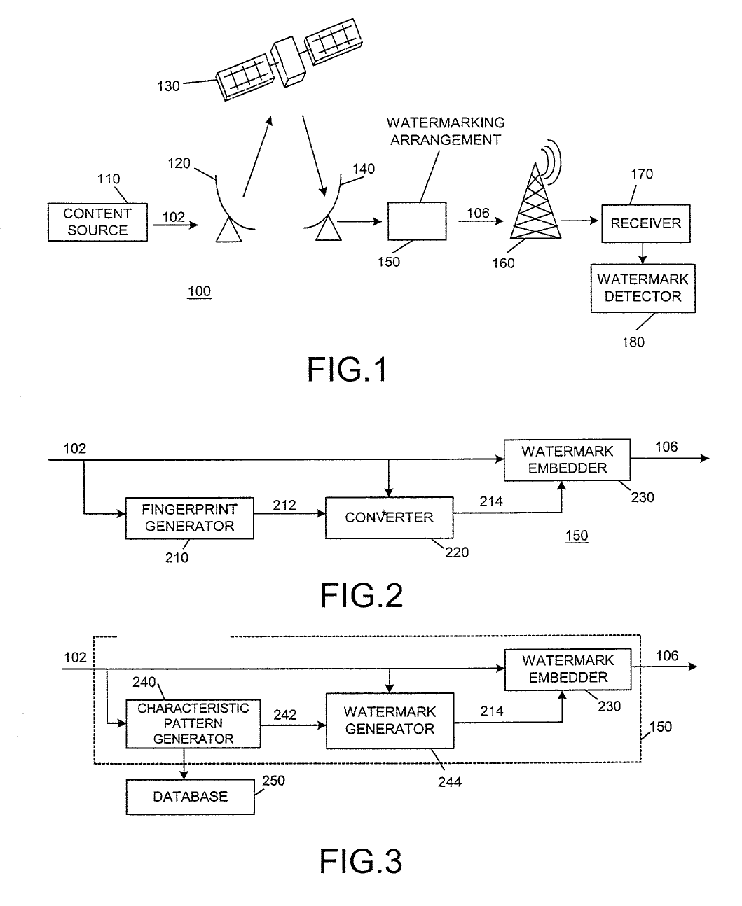

FIG. 1 illustrates an example of a path followed by content 102 from a content source 110 to a user. In this embodiment, the invention is illustrated in the context of information broadcast over a television network, a radio network or over any other sort of private or public information network, e.g. the Internet. Original content 102 is first transmitted from the content source 110 to a first emitting satellite antenna 120. The content source 110 may be where the content 102 was originally stored or created. For example, the source 110 can be part of a storage arrangement associated with an Internet server or the source 110 can be part of the storage arrangement of a TV or radio station. The source 110 can also be part of a storage area network (SAN) or can be implemented as a network-attached storage (NAS). Original content 102 is any sort of digital or analog audio, video, textual or other content, or a combination thereof, such as a Web page, a song, a video clip, a movie, a news article, a book and the like. Content 102 is transmitted over a satellite 130 to a receiving satellite antenna 140. A watermarking arrangement 150 computes a watermark from content 102. The watermark is incorporated in content 102 before further transmission resulting in marked content 106. The computed watermark is either perceptible or imperceptible to the user when marked content 106 is played out. As used herein, imperceptible indicates that the watermark is computed so that it does not alter content 106 in a way that would disturb the user experience.

In an example embodiment, the watermark identifies content 102 and permits to retrieve information related to content 102 as will be shown with reference to FIG. 2 and FIG. 3. Such information may be the trailer of a movie, a few seconds of a song, personal information on the artists, the lyrics of a song, a summary of an article, references for an essay and the like. In another embodiment, such information may be remotely stored in a database of records as a record associated with content 102. In this embodiment, the database is possibly browsed using watermarks of the invention.

Marked content 106 resulting from the watermarking process of the invention is then broadcast via an antenna 160 to a receiver 170. The receiver 170 is coupled with a watermark detector 180 equipped with the appropriate software that permits detecting and decoding the embedded watermark. The watermark detector 180 enables a user receiving and playing out marked content 106 to retrieve the content-related information, e.g. upon request as will be explained hereinafter.

An embodiment of the watermarking arrangement 150 is given in FIG. 2. In this embodiment, the watermarking arrangement 150 comprises fingerprint generator 210 configured to generate a fingerprint 212 from received content 102. As used herein a “fingerprint” is a characteristic pattern that allows identifying content 102. A converter 220 then computes a watermark 214 for content 102 on the basis of the fingerprint 212. In a possible way of computing the watermark 214, the converter 220 translates the fingerprint 212 into a watermark 214 so that content 102 can be identified using the watermark 214. Furthermore, additional information may be inserted in the watermark 214. Additional information can include, e.g., the name of a service provider deriving and embedding the watermark 214. This is described further with reference to FIG. 5. A watermark embedder 230 incorporates the derived watermark 214 in content 102. This is typically done before distribution thus resulting in marked content 106. It is also within the scope of the invention to consider an embodiment where the computing and the embedding performed by the converter 220 and the embedder 230, respectively, are combined and carried out as a single process.

In another embodiment of the watermarking arrangement 150 as depicted in FIG. 3, a generator 240 derives a characteristic pattern 242, e.g. a fingerprint or a hash, from content 102. In this embodiment, the characteristic pattern 242 is used to browse an existing database 250 of records. Each record gives information associated with a given piece of content. Each record is referenced in the database 250 with the respective characteristic pattern of the piece of content associated with the record. The generator 240 browses and searches the database 250 for a record associated with content 102 using the derived characteristic pattern 242. If a match is found, a watermark generator 244 derives the watermark 214 on the basis of the characteristic pattern 242. The generator 244 may derive the watermark 214 from data extracted from the record associated with content 102. The watermark 214 is then embedded in content 102 by the embedder 230. If no match is found, a record may be created for content 102 and added to the database 250. The record can be indexed using the characteristic pattern 242. The generator 244 derives the watermark 214 from the characteristic pattern 242. The watermark 244 is associated with this newly-created record of the database 250 comprising information related to content 102.

A possible way of deriving the characteristic pattern 242 or the fingerprint 212 is to use hash functions. Hash functions are well known in the art and allow deriving a hash number for each content, referred to as the hash. The hash is commonly used to retrieve content-related information or to verify the identity of a content by lookup to a database storing records for each content, the records being indexed by their hash. As mentioned previously, the hash is also commonly used to verify that the right content has been received and that the content received is undamaged.

Hashing and fingerprinting differ from watermarking. Watermarking requires modification of the content before distribution or transmission whereas fingerprinting requires no modification of the content before distribution. Fingerprinting often requires a database to be built to allow identifying the contents being distributed. In the invention, the fingerprint or the characteristic pattern which advantageously gives access to content-related information is translated into a watermark embedded in the content and as a consequence same access to the content-related information is rendered possible using the watermark.

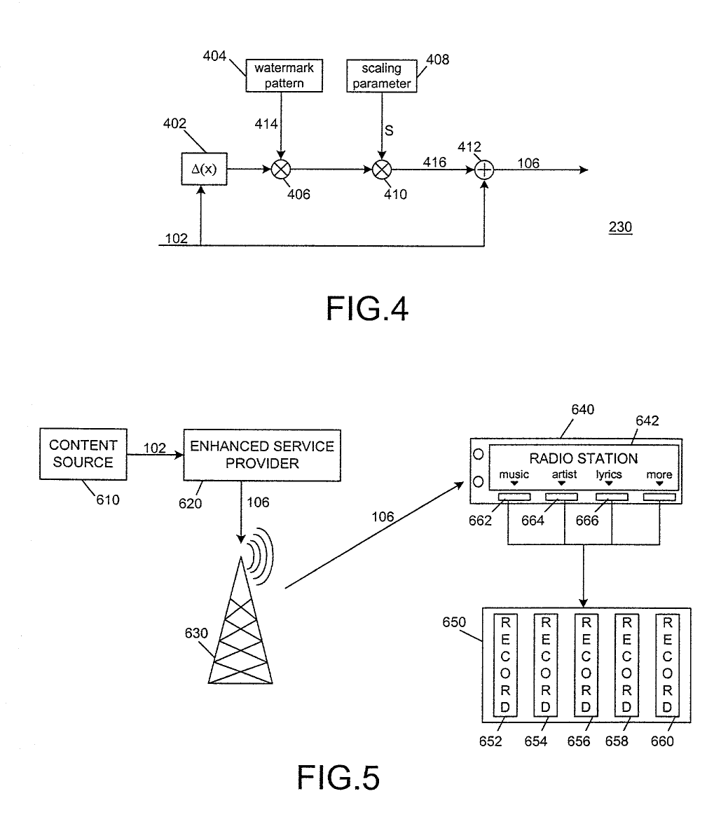

FIG. 4 is a block diagram of the watermark embedder 230 of the invention. The proposed watermark embedder 230 comprises a local map depth calculating arrangement 402, a unit 404 providing the watermark 414, a unit 408 providing the scaling parameter S, two multipliers 406 and 410 and an adder 412 providing the resulting marked content 106. From original content 102, a local depth map is calculated in the unit 402, which is used to scale in the multiplier 406 the watermark 414 provided by the unit 404. The result is then globally scaled in the multiplier 410 by the global scaling parameter S. The scaled watermark 416 is then added to content 102 resulting in marked content 106.

The block diagram of FIG. 5 illustrates an embodiment of a distribution scheme of marked content 106. In this embodiment, a service provider 620 offers an enhanced audio entertainment service. The provider 620 aims at enhancing any existing radio program or any other audio data services, e.g. live radio over the Internet, live radio on mobile phones, audio files delivery over the Internet. The provider 620 receives original digital content 102 from a content source 610. The provider 620 offers to transform received digital content 102 into enhanced digital content 106 according to the invention and to transmit to users enhanced digital content 106. In the invention, enhanced digital content 106 is obtained from processing original content 102 according to the invention. In the invention, the provider 620 provides the watermark 214 to give users access to content-related information. The entire process may be carried out anywhere in the transmission path from the source 610 to the user. The provider 620 may be an intermediate party in the transmission path, e.g. a radio station, a web-site for MP3 files download, etc . . . . The creator 610 of original content 102, e.g. the music industry, may offer the enhanced service without the help of an outside party and in this case the provider 610 of original content 102 would also be the provider 620 of this embodiment.

In this embodiment, the provider 620 is given access to a database 650 of 30 information records 652, 654, 656, 658 and 660. The provider 620 may create the database 650 or may get a license from a creator of the database 650 to use the information comprised in the database 650. The records 652-660 of the database 650 comprise information and details associated with respective contents. The database 650 can be browsed using characteristic patterns derived for contents. Thus, a record associated with content 106 can be retrieved using a characteristic pattern of content 102.

If the provider 620 creates the database 650, the provider 620 computes the characteristic pattern for content 102 and associates the characteristic pattern with a record in the database 650 comprising content-related information. The provider 620 then derives the watermark 214 to be embedded in marked content 106 on the basis of the characteristic pattern.

If the provider is provided with an existing database 650, the provider 620 computes the characteristic pattern and searches the database 650 for a record referenced with the computed characteristic pattern. If a match is found, the watermark 214 is derived on the basis of the characteristic pattern. The watermark 214 may also be derived on the basis of data retrieved from the record.

This embodiment is, here, given in the context of radio broadcast from the provider 620 via an antenna 630 to a receiving device 640. The receiving device 640 may be a car radio apparatus, a mobile phone equipped with radio reception capabilities, an internet radio player and the like. The device 640 comprises a display 642 to inform an individual listening to the radio station of additional information with respect to a piece of content being played out by the radio station. The enhanced service of the provider 620 indeed permits the individual to access further information related to content 106 played by the device 640. This information is stored in the database 650 and as mentioned earlier may be retrieved from the watermark 214. The device 640 is equipped with the appropriate software to detect and read the watermark 214.

In this embodiment, the individual has a choice of three categories 662, 664 and 666 of accessible content-related information to choose from: music, artist and lyrics. The categories 662-666 may vary for each given content being played out by the device 640. The device 640 is configured to determine the specific categories for content 106 from the watermark 214. Alternatively, content 106 comprises several watermarks 214 with each given watermark corresponding to a respective category 662, 664 or 666 of content-related information. By selecting one of the categories 662-666, the individual triggers one or more records 652-660 of the database 650 associated with content 106.

In another embodiment, the device 640 is configured to automatically retrieve the content related information from the record of the database 650 associated with content 106. The device 640 may store the retrieved content related information or may automatically display on the display 642 the content related information such as the title of the song and the name of the artist. Moreover the service provider 620 may decide to design the watermark 214 such that the provider 620 can be identified. For example, the provider 620 may incorporate in the watermark 214 data that enables to identify the radio station.

It is also within the scope of the invention to propose such an enhanced service for e.g. TV services, Web content, interactive services.

It is to be noted that, with respect to the described method, modifications may be proposed without departing from the scope of the invention. For instance, it is clear that this method may be implemented in several manners, such as by means of wired electronic circuits or, alternatively, by means of a set of instructions stored in a computer-readable medium, said instructions replacing at least a part of said circuits and being executable under the control of a computer or a digital processor in order to carry out the same functions as fulfilled in said replaced circuits. The invention is thus not limited to the examples provided.

The word “comprising” does not exclude the presence of other elements or steps than those listed in a claim.

What is claimed is:

1. A method for computing a watermark for a piece of content, the method comprises:
computing a characteristic pattern representative of the piece of content, the characteristic pattern being associated with content-related information; and,
computing the watermark for the piece of content from the characteristic pattern, the watermark enabling to access the content-related information.

2. The method of claim 1, wherein the characteristic pattern is a fingerprint.

3. The method of claim 1, wherein the watermark is further computed from the content-related information.

4. The method of claim 1, wherein the content-related information is stored in a remotely accessible database and referenced by the characteristic pattern.

5. The method of claim 1, further comprising:
incorporating in the watermark information data to identify a party transmitting the watermark.

6. The method of claim 1, wherein the watermark comprises the content-related information.

7. The method of claim 1, wherein the characteristic pattern comprises a hash derived from the piece of content.

8. The method of claim 1, further comprising:
embedding the watermark in the piece of content resulting in a marked content.

9. The method of claim 8, further comprising:
broadcasting the marked content.

10. The method of claim 8, further comprising:
transmitting the marked content over a radiotelephony network from a transmitting station to a handset; and,
enabling to access the content-related information from the handset.

11. The method of claim 8, further comprising:
broadcasting the marked content over a television network from a broadcast station to a set-top box; and,
enabling to access the content-related information from the set-top box.

12. A device for watermarking a piece of content, the device comprises:
deriving means configured to generate a characteristic pattern representative of the piece of content and configured to associate the characteristic pattern with content-related information;
watermarking means configured to compute a watermark for the piece of content on the basis of the characteristic pattern, the watermark enabling to access the content-related information

13. The device of claim 12, wherein the watermarking means is configured to embed the watermark in the piece of content resulting in a marked content.

14. The device of claim 12, wherein the device is an entertainment programs broadcasting station.

15. A device for detecting a watermark in a marked content, the device comprising:
watermarking detecting means for detecting in the marked content a watermark that was computed from a characteristic pattern representative of the marked content;
accessing means, coupled to the watermarking means, configured to retrieve, using the watermark, content-related information associated with the characteristic pattern.

16. A signal representing a marked content, the signal comprising:
a watermark enabling to access content-related information, and
wherein the watermark was derived on the basis of a characteristic pattern representative of the marked content , the characteristic pattern being associated with the content-related information.

17. A software application for carrying out a watermarking method, the method comprising:
computing a characteristic pattern representative of a piece of content, the characteristic pattern being associated with content-related information; and,
computing a watermark for the piece of content on the basis of the characteristic pattern, the watermark enabling to access the content-related information.
